(19) United States
(12) Patent Application Publication
(10) Pub. No.: US 2014/0056103 A1
(43) Pub. Date: Feb. 27, 2014

(54) SEISMIC SURVEY COMMUNICATION SYSTEMS AND METHODS

(71) Applicant: WESTERNGECO L.L.C., Houston, TX (US)

(72) Inventors: BRIAN LEE VIRGIN, Rykkinn (NO); GUILLAUME DANIEL TAMBOISE, Oslo (NO)

(73) Assignee: WESTERNGECO L.L.C., Houston, TX (US)

(21) Appl. No.: 13/788,927

(22) Filed: Mar. 7, 2013

Related U.S. Application Data
(60) Provisional application No. 61/692,106, filed on Aug. 22, 2012.

(51) Int. Cl. G01V 1/22

(52) U.S. Cl. CPC G01V 1/22
USPC 367/76

(57) ABSTRACT

Systems and methods for seismic survey communications. In one implementation, the method may include receiving a first network address to a sensor node. The first network address may correspond to a primary logical path between the sensor node and a recording server. The primary logical path may also include a first router dedicated to the primary logical path. The method may also include receiving a second network address to the sensor node. The second network address may correspond to a secondary logical path between the sensor node and the recording server. The secondary logical path may also include a second router dedicated to the secondary logical path. The method may further include sending seismic data to the recording server using the first network address.

### CROSS-REFERENCE TO RELATED APPLICATION

This application claims benefit of U.S. Provisional Patent Application Ser. No. 61/692,106 filed Aug. 22, 2012, which is incorporated herein by reference in its entirety.

### BACKGROUND

1. Field of the Invention

Implementations of various technologies described herein generally relate to seismic survey communication systems and methods.

2. Description of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Seismic exploration may utilize a seismic energy source to generate acoustic signals that propagate into the earth and partially reflect off subsurface seismic reflectors (e.g., interfaces between subsurface layers). The reflected signals are recorded by sensors (e.g., receivers or geophones located in seismic units) laid out in a seismic spread covering a region of the earth's surface. The recorded signals may then be processed to yield a seismic survey. An example of such a seismic spread may involve a deployment of sensors in a grid configuration across the surface of a region of interest. In this grid configuration, one line of sensors may extend for thousands of meters with sensors placed along the line at predetermined locations. Several sensor lines may then be separated to span the region and form a seismic acquisition network.

To operate and collect seismic data across a seismic spread, an acquisition network may implement a transmission system that couples sensors to a recording server. This recording server may be located on a recording truck or another network unit that may be either stationary or mobile. During an actual survey, the recording server collects data (e.g., seismic data, quality control data, positioning data, etc.) related to the sensors and seismic spread. Data transmission may occur over wired connections between network nodes such as individual sensors, routers, fiber backbones, the recording server, and any other network components, but wireless methods may also be employed for this data transmission. For transmitting sensor data, the data may be sent using respective network channels in order to communicate with the recording server. As an example, for an acquisition network with a hundred thousand sensors, there may be a hundred thousand channels supported by the network.

To manage this huge volume of data, network protocols may implement flow control, congestion control, fault tolerance and any other mechanisms on the acquisition network to make the data communication stable and run smoothly. In a seismic spread that includes thousands of sensors, network malfunctions that harm an isolated part of the network may result in an incomplete seismic survey that limits the value of the rest of the acquired seismic data as well as possible survey downtime to fix the problem. When routers and sensor lines go down, sensors depending on the network infrastructure may go down with them. Implementing flexible network protocols to handle these kinds of situations may be one solution to the problem. In any case, developing a robust seismic acquisition network capable of withstanding these types of scenarios is a major objective for improving seismic surveying.

### SUMMARY

Described herein are implementations of various technologies for a method, which may include receiving a first network address for a sensor node. The first network address may correspond to a primary logical path between the sensor node and a recording server. The primary logical path may also include a first router dedicated to the primary logical path. The method may also include receiving a second network address for the sensor node. The second network address may correspond to a secondary logical path between the sensor node and the recording server. The secondary logical path may also include a second router dedicated to the secondary logical path. The method may then send seismic data to the recording server using the first network address.

In one implementation, the sensor node may include a multi-component sensor that measures a plurality of seismic components. The method may also include sending the seismic data for each component of the plurality of seismic components in a respective stream using a network protocol. The seismic data for the plurality of seismic components may also include seismic data in the x-direction, y-direction, z-direction, or a combination thereof. The method may also include determining whether a seismic data acknowledgment for at least one respective stream passes a predetermined criterion. Passing the predetermined criteria may include receiving at least one seismic data acknowledgment for a respective stream. The predetermined criteria may also be based on receiving the seismic data acknowledgment within a predetermined time window. The method may also include sending the seismic data using the second network address in response to determining that the seismic data acknowledgment for at least one of the respective streams failed the predetermined criteria.

In another implementation, the secondary logical path may use at least one network cable that provides a network connection between the second router and the recording server, where the at least one network cable is independent from the network cables used by the primary logical path for network routing.

In yet another implementation, the method may include sending a heartbeat message to the recording server using the second network address. The method may also include determining whether a heartbeat acknowledgment corresponding to the heartbeat message passes a predetermined criterion. The heartbeat acknowledgment passing the predetermined criteria may include receiving the heartbeat acknowledgment at the sensor node. The method may also include determining whether a seismic data acknowledgment in response to the seismic data passes a predetermined criterion. The method may also include sending the seismic data using the second network address in response to determining that the seismic data acknowledgment failed the predetermined criteria for the seismic data acknowledgment and the heartbeat acknowledgment passed the predetermined criteria for the heartbeat acknowledgment. The predetermined criteria for the seismic data acknowledgment or the heartbeat acknowledgment may be based on receiving the seismic data acknowledgment within a predetermined time window.

Described herein are implementations of various technologies for a method, which may include receiving a first network address for a sensor node. The first network address may correspond to a primary logical path between the sensor node and a recording server. The primary logical path may also include a first router dedicated to the primary logical path. The method may also include receiving a second network address to the sensor node. The second network address may correspond to a secondary logical path between the sensor node and the recording server. The secondary logical path may also include a second router dedicated to the secondary logical path. The method may include receiving seismic data from the sensor node. The method may also include sending, using the first network address, a seismic data acknowledgment to the sensor node in response to receiving the seismic data.

In one implementation, the method may include sending a first heartbeat message to the sensor node using the first network address. The method may also include determining whether a first heartbeat acknowledgment corresponding to the first heartbeat message passes a predetermined criterion. The method may also include sending a second heartbeat message to the sensor node using the second network address. The method may also include determining whether a second heartbeat acknowledgment corresponding to the second heartbeat message passes the predetermined criteria. The method may also include sending the seismic data acknowledgement to the sensor node using the second network address in response to determining that the first heartbeat acknowledgment failed the predetermined criteria and the second heartbeat acknowledgment passed the predetermined criteria.

Described herein are implementations of various technologies for a seismic acquisition system, which may include a recording server for collecting seismic data. The seismic acquisition system may also include a plurality of seismic sensor nodes for acquiring seismic data. The seismic acquisition system may also include a first router configured to assign a first network address to at least one of the seismic sensor nodes for sending seismic data from the at least one of the seismic sensor nodes to the recording server through a primary logical path. The seismic acquisition system may also include a second router configured to assign a second network address to at least one of the seismic sensor nodes for sending a heartbeat message from the at least one of the seismic sensor nodes to the recording server through a secondary logical path.

In one implementation, the plurality of seismic sensor nodes may be along a sensor strip, where the first router is connected to a first end of the sensor strip and the second router is connected to a second end of the sensor strip. In another implementation, the recording server may be configured to send a seismic data acknowledgment to the at least one of the seismic sensor nodes using the first network address in response to receiving seismic data. In yet another implementation, the at least one of the seismic sensor nodes may be configured to switch from sending seismic data using the first network address to sending seismic data using the second network address in response to a failed seismic data acknowledgment through the first network address based on a predetermined criterion.

In some implementations, a computing system is provided that includes at least one processor, at least one memory, and one or more programs stored in the at least one memory, wherein the programs include instructions, which when executed by the at least one processor cause the computing system to receive a first network address for a sensor node. The first network address may correspond to a primary logical path between the sensor node and a recording server. The primary logical path may also include a first router dedicated to the primary logical path. The programs may further include instructions to cause the computing system to receive a second network address to the sensor node. The second network address may correspond to a secondary logical path between the sensor node and the recording server. The secondary logical path may also include a second router dedicated to the secondary logical path. The programs may further include instructions to cause the computing system to send seismic data to the recording server using the first network address.

In some implementations, a computing system is provided that includes at least one processor, at least one memory, and one or more programs stored in the at least one memory, wherein the programs include instructions, which when executed by the at least one processor cause the computing system to receive a first network address for a sensor node. The first network address may correspond to a primary logical path between the sensor node and a recording server. The primary logical path may also include a first router dedicated to the primary logical path. The programs may further include instructions to cause the computing system to receive a second network address to the sensor node. The second network address may correspond to a secondary logical path between the sensor node and the recording server. The secondary logical path may also include a second router dedicated to the secondary logical path. The programs may further include instructions to cause the computing system to receive seismic data from the sensor node. The program may further include instructions to cause the computing system to send, using the first network address, a seismic data acknowledgment to the sensor node in response to receiving the seismic data.

In some implementations, a computer readable storage medium is provided, which has stored therein one or more programs, the one or more programs including instructions, which when executed by a processor, cause the processor to receive a first network address to a sensor node. The first network address may correspond to a primary logical path between the sensor node and a recording server. The primary logical path may also include a first router dedicated to the primary logical path. The programs may further include instructions, which cause the processor to receive a second network address to the sensor node. The second network address may correspond to a secondary logical path between the sensor node and the recording server. The secondary logical path may also include a second router dedicated to the secondary logical path. The programs may further include instructions, which cause the processor to send seismic data to the recording server using the first network address.

In some implementations, a computer readable storage medium is provided, which has stored therein one or more programs, the one or more programs including instructions, which when executed by a processor, cause the processor to receive a first network address for a sensor node. The first network address may correspond to a primary logical path between the sensor node and a recording server. The primary logical path may also include a first router dedicated to the primary logical path. The programs may further include instructions to cause the processor to receive a second network address to the sensor node. The second network address may correspond to a secondary logical path between the sensor node and the recording server. The secondary logical path may also include a second router dedicated to the secondary logical path. The programs may further include instructions to cause the processor to receive seismic data from the sensor node. The programs may further include instructions to cause the processor to send, using the first network address, a seismic data acknowledgment to the sensor node in response to receiving the seismic data.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a seismic acquisition system in accordance with various implementations described herein.

FIG. 2 illustrates a flow diagram of a method for managing system faults in accordance with various implementations described herein.

FIG. 3 illustrates a flow diagram of a method for managing system faults in accordance with various implementations described herein

FIG. 4 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

The following paragraphs provide a brief summary of the various techniques described herein. In one aspect, various techniques described herein are directed to a seismic acquisition system that includes seismic sensors along individual sensor strips, where the sensors communicate with a recording server across an acquisition network. On the acquisition network, individual sensors or groups of sensors may serve as a sensor node. To prevent or reduce damage by faults that occur in the acquisition network, network protocols may implement methods of managing system faults. This fault management may also be referred to as implementing fail-over decisions or fault tolerance.

In the seismic acquisition system, the two ends of each sensor strip are connected to a router, such as Router R1 and Router R2, respectively. A respective sensor node on a particular strip may be dynamically or statically assigned two network addresses (e.g., Internet Protocol (IP) addresses), one network address by each of the two routers. Each network address may be associated with a logical path from one router to the recording server. The first logical path, which may be called the primary logical path, corresponds to one network address, and is configured to transmit seismic data from the respective sensor node to the recording server. A second logical path, which may be called the secondary logical path, corresponds to the second network address, and may be configured to transmit a heartbeat message from the respective sensor node to the recording server. Router R1 may be dedicated to the primary logical path, while Router 2 may be dedicated to the secondary logical path.

Upon receiving seismic data from the respective sensor node, the recording server may send an acknowledgment in response to the seismic data (“seismic data acknowledgment”) back to the sensor node. The respective sensor node may be configured to switch from the primary logical path to the secondary logical path for sending seismic data in response to receiving an unsatisfactory acknowledgement (i.e., no acknowledgment or an untimely delayed one) regarding receipt of seismic data by the recording server.

In regard to this seismic acquisition system, a heartbeat message is a data message sent from one endpoint to a second endpoint (e.g., a sensor node as one endpoint and the recording server as the other endpoint) that requests an acknowledgement of the heartbeat message (“heartbeat acknowledgment”) from the second endpoint to verify that a logical path is satisfactory or still operational. A predetermined criterion may be in place to determine whether any expected heartbeat acknowledgments are satisfactory or acceptable. If a sensor node receives no satisfactory heartbeat acknowledgment, then the particular logical path may fail the predetermined criteria. The lack of a timely heartbeat acknowledgment may be due to a physical line break or congestion in the network, or for some other reasons.

In another implementation, seismic data acknowledgments, heartbeat messages and heartbeat acknowledgments may be based entirely or in part on acknowledgments and heartbeat messages used in the Stream Control Transmission Protocol (SCTP). For instance, the heartbeat messages may be SCTP heartbeat messages and the heartbeat acknowledgments may be SCTP heartbeat acknowledgments.

Furthermore, the recording server may transmit a seismic data acknowledgement to the respective sensor node in response to receiving seismic data from the respective sensor node via the primary logical path. The recording server may also be configured to switch from using the primary logical path to using the secondary logical path for sending a seismic data acknowledgement in response to a heartbeat acknowledgment for the primary logical path that fails to pass a predetermined criterion.

In another aspect, various techniques described herein are directed to a method of managing system faults from the perspective of a sensor node. In this implementation, a sensor node receives two network addresses: a first network address corresponding to a Router R1 that is dedicated to the primary logical path, and a second network address corresponding to Router R2 that is dedicated to the secondary logical path. The sensor node then sends seismic data to the recording server along the primary logical path using the first network address. The sensor node also sends a heartbeat message to the recording server along the secondary logical path using the second network address. If the sensor node fails to receive a heartbeat acknowledgement from the recording server that passes a predetermined criterion, the sensor node may determine that the secondary logical path is not operational or unsatisfactory. If the sensor node fails to receive a seismic data acknowledgement from the recording server that passes a predetermined criteria, the sensor node may send seismic data along the secondary logical path, but only if the secondary logical path is determined to be satisfactory or still operational. This determination that the secondary logical path is satisfactory may be made by the sensor node previously receiving a heartbeat acknowledgment for the secondary logical path that passes a predetermined criterion.

In yet another aspect, various techniques described herein are also directed to a method for managing system faults from the perspective of a recording server. In this implementation, the recording server receives two network addresses associated with a sensor node: a first network address corresponding to Router R1 that is dedicated to the primary logical path, and a second network address corresponding to Router R2 that is dedicated the secondary logical path. The recording server then sends a first heartbeat message to the sensor node along a primary logical path using the sensor node's first network address. Additionally, the recording server sends a second heartbeat message to the sensor node along a secondary logical path using the sensor node's second network address. When the recording server receives seismic data from the respective sensor node, the recording server sends a seismic data acknowledgement to the sensor along the primary logical path. If the recording server fails to receive an acknowledgement for the first heartbeat message from the sensor node for the primary logical path, then the recording server may switch to using the secondary logical path for sending the seismic data acknowledgement. However, the recording server may use the secondary logical path if an acknowledgment for a heartbeat message passes a predetermined criterion for the secondary logical path.

In yet another aspect, various techniques described herein are also directed to a method for multiplexing sensor data. For example, a sensor node may send data corresponding to a particular sensor component (e.g., seismic data in the x-direction or y-direction) in a respective stream of data using a network protocol. These streams of component data are sent over a logical path from the sensor node to the recording server. If any particular stream is lost during transmission using the logical path, only seismic data regarding the component associated with that respective stream may be lost or delayed. Seismic component data included in the other successful streams may not be lost or delayed. For example, x-direction data may be lost, but y-direction and z-direction data may make it through. If the sensor node fails to receive a seismic data acknowledgement for any particular stream from the recording server, the sensor node may switch from using the current designated network address (corresponding to the primary logical path at default) to a different network address (corresponding to the secondary logical path at default) for sending future seismic data.

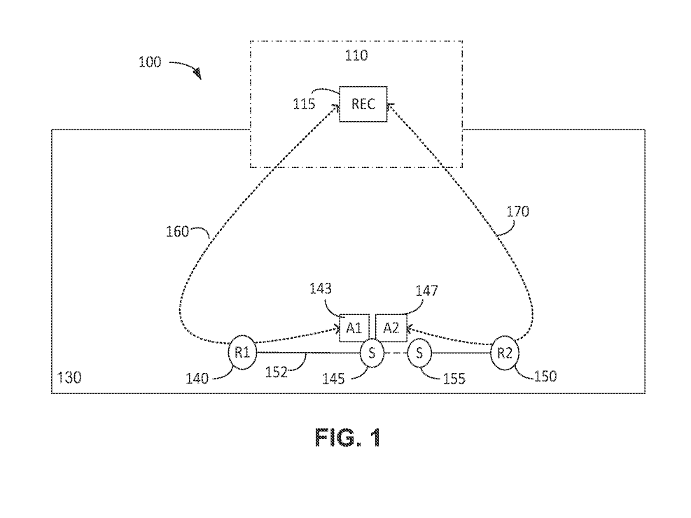

FIG. 1 illustrates a schematic diagram of a seismic acquisition system 100 in accordance with various implementations described herein. The seismic acquisition system 100 includes a recording server 110 for recording seismic data and an acquisition network 130 for collecting seismic data throughout a seismic spread. The acquisition network 130 may include a variety of network nodes, such as routers, fiber backbones, sensor nodes, and other network components. For instance, the acquisition network 130 in FIG. 1 includes a first router 140 and a second router 150, both of which may be treated as network nodes. The first router 140 and the second router 150 are connected along a sensor strip 152 or sensor line that supports a sensor node 145 and an additional sensor node 155. The first router 140 is connected to a first end of the sensor strip 152, and the second router 150 is connected to a second end of the sensor strip 152. While one additional sensor node is shown in FIG. 1, the sensor strip 152 may include any number of sensor nodes in addition to the additional sensor node 155. Also, while the sensor strip 152 is shown as a straight line in FIG. 1, other geometries of sensor strips are also imagined, such as configurations that may have any number of ends and any number of routers connected to the sensor strip 152.

The sensor node 145 may include a seismic sensor, a positioning sensor, a group of sensors, or any other device capable of receiving data from sensors and transmitting the data to a destination node. The term “sensor node” describes a connection endpoint that is capable of sending seismic data received from sensors. Individual sensors may be built into the sensor node 145, or the sensor data may be sent to the sensor node 145 over a local area network. For instance, one sensor node may represent one sensor, but other implementations are imagined where the sensor node supports a plurality of sensors, such as in the case of a multi-component sensor. Types of sensors used by the sensor node 145 may include geophones, hydrophones, accelerometers, such as a geophone accelerometer (GAC), microelectromechanical system (MEMS) devices, or any other type of device used for taking physical measurements.

In regard to data communication, several network protocols manage the seismic acquisition system 100 by operating between and on various network nodes. The term “network protocol” is meant to be an inclusive term. In categorizing network protocols, different logical layers (e.g., the network layer, the transport layer, the application layer, etc.) defined by the Open Systems Interconnection (OSI) model may describe the scope of a particular network protocol. For example, a transport protocol may specify flow control, congestion avoidance and error detection between endpoints in a network connection, and these activities may be considered within the transport layer of the OSI model. Another network protocol may determine the format of a data message and how the data message with a source address of one endpoint or sending device may be delivered to a destination address for a second endpoint. In one implementation, the network protocols administering the seismic acquisition system 100 may be based in part or completely on the Stream Control Transmission Protocol (SCTP). For more information on SCTP, see Stewart et al., The Internet Engineering Task Force (IETF) Request for Comments (RFC) 2960 (October 2000) (“RFC 2960”), which is incorporated by reference. See also R. Stewart, The Internet Engineering Task Force (IETF) Request for Comments (RFC) 4960 (September 2007) (“RFC 4960”), which is also incorporated by reference. See also L. Coene, The Internet Engineering Task Force (IETF) “Multihoming issues in the Stream Control Transmission Protocol”, version 4, (June 2003), which is also incorporated by reference.

The term “endpoint” may refer to the logical sender/receiver of a data message. For example, the recording server 110 may be one endpoint and the sensor node 145 may be a second endpoint.

The term “multi-homing” may refer to the configuring of multiple network or virtual interfaces or network addresses for an endpoint. For example, an endpoint on a network may be represented to its peers as a combination of a set of eligible destination addresses or Internet Protocol (IP) addresses to which data messages may be sent and a set of eligible source addresses from which data messages may be received.

The term “data message,” which will be used henceforth, is a comprehensive term that includes packets and datagrams sent over a network. A data message may correspond to a header format defined for addressing bytes of data from the data message's source location to a destination location on the network. The header format may be defined by one or more network protocols.

Keeping with FIG. 1, the sensor node 145 has a first network address 143 and a second network address 147. In this instance, the sensor node 145 qualifies as a multi-homed host, because the sensor node 145 is represented to other nodes in the seismic acquisition system 100 as having two network addresses. While the sensor node 145 has two network addresses, other implementations are imagined where the sensor node 145 may have any number of network addresses. These network addresses may be Internet Protocol (IP) addresses, but other address types, such as hardware addresses like Medium Access Control (MAC) addresses or addresses for other network protocols, may be used as well. Sensor nodes may obtain network addresses through any network method used by a network to designate hosts or nodes for producing network connections. In one implementation, the first router 140 assigns the first network address 143 to the sensor node 145, while the second router 150 assigns the second network address 147 to the sensor node 145. However, network addresses may be assigned by a variety of means and by many different network components. Likewise, assigning a network address may be done statically, where network addresses do not change, or dynamically, where network addresses may be changed periodically, whenever the seismic acquisition system's 100 starts-up, or for a variety of reasons.

The recording server 110 has a recording server address 115 that is a network address used for sending and receiving data through the seismic acquisition system 100. The recording server address 115 may be obtained and assigned in the same manner as the network addresses used by the sensor node 145. While the recording server 110 has one network address in FIG. 1, other implementations are imagined where the recording server 110 has any number of network addresses for use in communication with other network nodes. In a seismic survey, the recording server 110 receives seismic data from the sensor node 145 as well as other sensor nodes in the acquisition network 130.

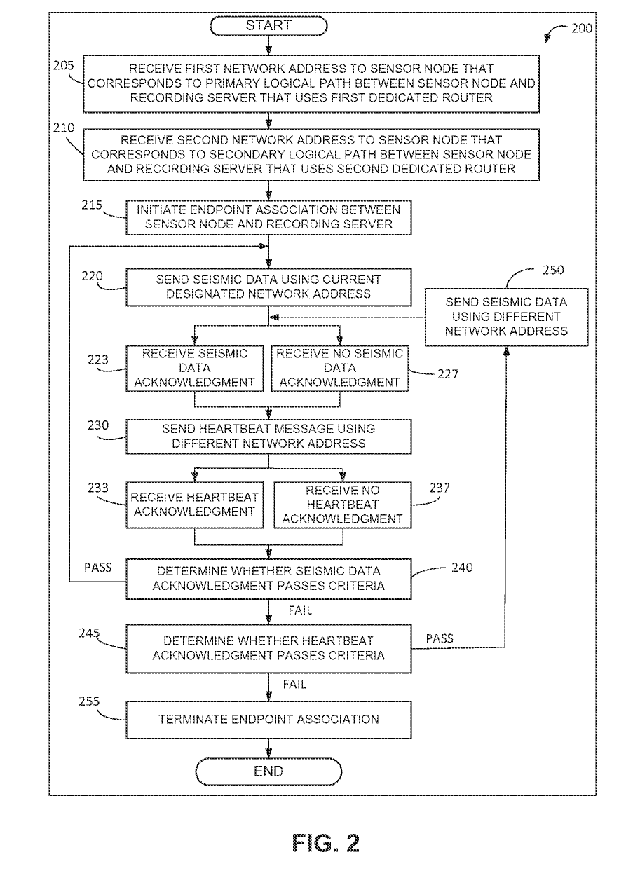

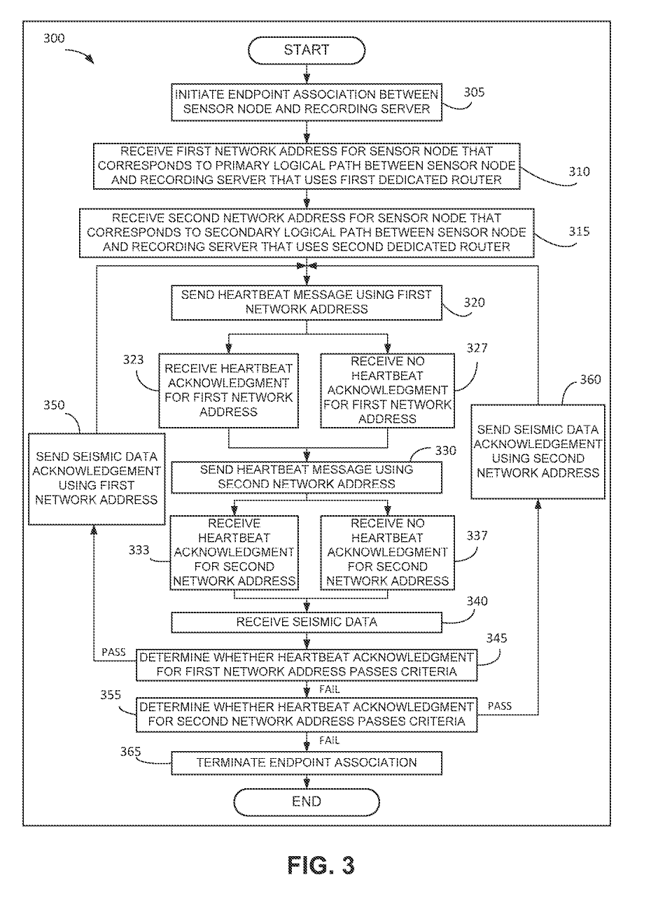

Upon receiving seismic data from the sensor node 145, the recording server 110 may reply with a seismic data acknowledgment back to the sensor node 145. A data acknowledgment, for example, is a data message sent by one endpoint to another endpoint acknowledging that a specific data message was previously received. In this case, where the recording server 110 is receiving seismic data, the recording server 110 is the receiving endpoint, while the sensor node 145 that is sending the seismic data is the sending endpoint. As such, the recording server 110 would send a seismic data acknowledgment back to the sensor node 145 telling the sensor node 145 that the seismic data was received. Data communication between the sensor node 145 and the recording server 110 is further described with reference to FIGS. 2-3 and the accompanying paragraphs.

In FIG. 1, the first router 140 supports a primary logical path 160 between the sensor node 145 and the recording server 110. In regard to networking terminology, a logical path, as opposed to a physical path, describes how data is transmitted through a network using network protocols. A logical path connects data sent from a source address to a destination address over a network connection or endpoint association. For example, physical network nodes serve as intermediary points for data transfer across a network. A logical path determines which network nodes are used for transporting data from a source address to a destination address. Each network node used in the logical path may be referred to as a hop. As such, the list of hops used in a network connection may correspond to the actual physical path being used at that time by the logical path. In implementing a logical path, the choice of network nodes for use as hops may be static, but a logical path may include dynamically reconfiguring the chosen hops throughout network operations.

Furthermore, the second router 150 supports a secondary logical path 170 between the sensor node 145 and the recording server 110. The secondary logical path 170 is a logical path similar to the primary logical path 160, and corresponds to data sent across the acquisition network 130 using the second network address 147. In the acquisition network 130, the primary logical path 160 and the secondary logical path 170 may share hops between the sensor node 145 and the recording server 110 except the first hop, which may correspond to either the first router 140 or the second router 150. The secondary logical path 170 may also serve as a backup path for sending seismic data or seismic data acknowledgments between the sensor node 145 and the recording server 110.

Network addresses may also be described as either source address or destination addresses. For sending seismic data along the primary logical path 160, the first network address 143 may be the source address, while the recording server address 115 may be the destination address. For sending a seismic data acknowledgment back to the sensor node 145, the recording server address 115 may be the source address while the first network address 143 may be the destination address.

In regard to the acquisition network's 130 reliability, line breaks may provide a regular problem associated with land seismic survey operations. During a seismic survey, physical network connections between sensor nodes and the recording server 110 may be severed by disturbances inherent to the terrain or third party interferences, or resulting from moving portions of the acquisition network to other areas for surveying. If not quickly remedied, line breaks may prevent some sensor nodes from communicating with the recording server 110. Some attempts to remedy such network issues include implementing network protocols with built-in fault tolerance methods and data buffering to ensure data is not lost in the time necessary for restoring a network connection resulting from a line break. However, these network protocols may be difficult to implement using acquisition sensors due to each sensor's relatively low CPU power and low memory. These methods for providing fault tolerance also do not take into account the near real time requirements for receiving shot data from sensors in a seismic survey.

One method of implementing fault tolerance is the use of data buffers placed throughout the acquisition network on seismic sensors or intermediate nodes. Uncompressed seismic data sampled at 1 ms and encoded on 24 bits, for example, may require a total of close to 3 kBytes of payload buffer per second. Two main factors may limit the size of these buffers: (a) for cost and power consumption reasons, acquisition sensors may not embed large amounts of memory, and (b) real-time quality control of seismic data may require that acquired seismic data is not validated too late after the triggered seismic source, in order to maintain good productivity. An appropriate buffer depth may lie between 150 ms allowed to VoIP systems and the move-up time of a vibrator (measured in tens of seconds), tuned according to the specifics of the rest of an acquisition system. The buffering capabilities may then drive the requirements for the redundancy mechanisms implemented in the end-to-end connectivity service.

The seismic acquisition system 100, having the primary logical path 160 and the secondary logical path 170 supported by the first router 140 and the second router 150, respectively, provides another network mechanism for overcoming these issues with line breaks. In one implementation, the secondary logical path 170 uses at least one network cable that provides a network connection between the second router 150 and the recording server 110 that is independent of the network cables used by the primary logical path 160. Likewise, the primary logical path 170 uses at least one network cable that provides a network connection between the first router 150 and the recording server 110 that is independent of the network cables used by the secondary logical path 160. In the case of a line break in the acquisition network 130, the primary logical path 160 may cease to operate partly, completely, or at a satisfactory performance. By utilizing an independent network cable, the secondary logical path 170 provides a working network connection between the sensor node 145 and the recording server 110.

In one implementation, a portion of the acquisition network 130 that is available as hops in the secondary logical path 170 is excluded from consideration as hops in the primary logical path 160. In another implementation, a portion of the acquisition network 130 that is available as hops in the primary logical path 160 is excluded from consideration as hops in the secondary logical path 170. By having dedicated hops to the primary logical path 160 or the secondary logical path 170, the seismic acquisition system 100 may be prepared to withstand line breaks.

FIG. 2 illustrates a flow diagram of a method 200 for managing system faults from the perspective of the sensor node 145 in accordance with various implementations described herein. In one implementation, method 200 may be performed by the sensor node 145, and also by the routers in certain aspects. It should be understood that while the operational flow diagram indicates a particular order of execution of the operations, in other implementations, the operations might be executed in a different order. Further, in some implementations, additional operations or steps may be added to the method 200. Likewise, some operations or steps may be omitted.

At step 205, the sensor node 145 receives the first network address 143 that corresponds to the primary logical path 160 between the sensor node 145 and the recording server 110. The first router 140, or some other network component, may assign the first network address 143 to the sensor node 145. The first router 140 may be dedicated to only the primary logical path 160. A dedicated router may be available for use with one designated logical path, and not with another logical path. For instance, a list of available hops for one logical path may not include a router dedicated to another logical path.

At step 210, the sensor node 145 receives the second network address 147 that corresponds to the secondary logical path 170 between the sensor node 145 and the recording server 110. The second router 150, or some other network component, may assign the second network address 147 to the sensor node 145. The second router 150 may be dedicated to only the secondary logical path 170. In this instance, the sensor node 145 is a multi-homed host with two network addresses. Using two source addresses may also be referred to as source-based routing.

In one implementation, the sensor node 145 may have as many dedicated routers for logical paths as the sensor node 145 has network addresses.

At step 215, the sensor node 145 or the recording server 110 initiates an endpoint association between both endpoints. An endpoint association is a network protocol relationship that governs how two endpoints communicate with each other. For instance, in an endpoint association one endpoint may provide the other endpoint with a list of network addresses (e.g., multiple IP addresses) from which the endpoints may be reached. The network addresses in the list may be unique to that endpoint in the seismic acquisition system 100. In one implementation, only a single endpoint association exists between the sensor node 145 and the recording server 110. In building the endpoint association between the recording server 110 and the sensor node 145, the recording server 110 may receive knowledge of the first network address 143 and the second network address 147 assigned to the sensor node 145. Likewise, the sensor node 145 may receive knowledge of the recording server address 115. At step 220, the sensor node 145 sends seismic data using a current designated network address. The seismic data may be pressure data, particle motion data, or any other kind of information such as timestamps or positioning data that may be directly or indirectly related to seismic measurements. Initially, the sensor node 145 may transmit seismic data using the first network address 143, or any other designated network address set as the system default. However, the current designated address may change based upon other steps in the method 200 or other events transpiring in the seismic acquisition system 100. In step 250, for instance, the current designated network address may be set to the second network address 147.

In one implementation, data messages, such as ones for seismic data, may be multiplexed through the acquisition network 130 in “streams.” For instance, a type of data message (e.g., seismic data or heartbeat messages) may be designated to a respective stream. The seismic acquisition system 100 may deliver and administer individual data messages with respect to other messages within the same stream. For example, seismic data messages may be recorded at the recording server 110 in the order they are transmitted by the sensor node 145 rather than in the order they are received by the recording server 110. Furthermore, the endpoint association between the recording server 110 and the sensor node 145 may specify the number of streams available or supported by the endpoint association. The total number of streams supported by the endpoint association may be as few as one or any other number. This method of multiplexing data may be performed without head-of-line blocking, which is used with some network protocols. For example, head-of-line blocking may be where a line of data messages are held up by a first data message, at a buffering switch for instance, in order to administer ordered delivery of the data messages or other network functions.

For a particular stream, a network protocol may assign a Stream Sequence Number (SSN) to each data message passed to it by the sensor node 145 or the recording server 110. This SSN allows either endpoint to determine whether a data message in a particular stream is missing. For a receiving endpoint, the network protocol may also ensure that messages are delivered to the endpoint in sequence within a given stream. However, while one stream may be blocked waiting for the next in-sequence data message, delivery for other streams may proceed. In addition to stream sequence numbers, a network protocol may specify a Transmission Sequence Number (TSN) for ordering messages between streams.

One example of sending seismic data in streams may involve a multi-component sensor. In this case, particular sensor components may be associated with particular stream numbers. The multi-component sensor may transmit particle motion data describing the x-direction using stream 1, while the same multi-component sensor may transmit particle motion data describing the y-direction using stream 3.

At step 223, the sensor node 145 receives a seismic data acknowledgment from the recording server 110 in response to the seismic data sent in step 220. The seismic data acknowledgment may be a data message that confirms receipt of one or several streams of seismic data. Where several streams are used, the recording server 110 may respond with a seismic data acknowledgment for each stream of seismic data. Where the seismic data for only some of the streams makes it to the recording server 110, a corresponding portion of the total seismic data acknowledgments may only be transmitted back to the sensor node 145. In step 223, the sensor node 145 may receive the portion or all of the seismic data acknowledgments sent from the recording server 110. Likewise, the seismic data acknowledgement may include the stream sequence number (SSN) or the transmission sequence number (TSN) of the corresponding seismic data message.

At step 227, the sensor node 145 fails to receive the seismic data acknowledgment sent in step 220. This failure may be the result of congestion in the seismic acquisition system 100, a line break that prevents a logical path forming for the designated network address, a malfunctioning sensor node or recording server, or any other reasons. In this step, the sensor node 145 may fail to receive a portion or all of the seismic data acknowledgments sent from the recording server 110 in response to the seismic data sent in step 220.

In steps 230-237, the process may transmit a heartbeat message and heartbeat acknowledgment in response to the heartbeat message as a method for verifying whether the secondary logical path 170 is operational or satisfactory. Steps 230-237 may also be used to verify whether the primary logical path 160 has been restored to operation, for example, where sending seismic data has already switched over to using the second network address 147.

At step 230, the sensor node 145 sends a heartbeat message to the recording server 110 using a different network address from the one used to send seismic data. For example, if the current designated network address is the first network address 143, then the different network address may be the second network address 147 assigned in step 210.

The heartbeat message, mentioned in step 230, is a data message sent from one endpoint to a second endpoint (e.g., the sensor node 145 as one endpoint and the recording server 110 as the second endpoint) requesting an acknowledgement in order to verify a logical path is still operational for a particular network address. If the requesting endpoint receives no acceptable heartbeat acknowledgement in response to the heartbeat message, then the particular logical path may be deemed “bad” or “inoperative.” A “bad,” “unsatisfactory” or “inoperative” logical path is deemed unreliable in the seismic acquisition system 100 and may result in data loss if used. Predetermined criteria for determining whether a heartbeat acknowledgment is acceptable or satisfactory may be found in step 245.

Keeping with step 230, the sensor node 145 may send the heartbeat message using a predetermined interval. For example, the sensor node 145 may send one heartbeat message for every ten streams of seismic data sent to the recording server 110. In another instance, the sensor node 145 may use a clock to send a heartbeat message at a particular time interval, such as every ten microseconds.

In one implementation, the sensor node 145 sends two or more heartbeat messages in step 230. These heartbeat messages may be sent at substantially the same time or at different times. In the case of multiple heartbeat messages, the sensor node 145 may use the heartbeat messages to test the respective logical path and determine an objective score or rating for the logical path. This approach may prevent the reliance on a single heartbeat message getting through to the recording server 110, and instead provide a more accurate indication of the path's reliability.

At step 233, the sensor node 145 receives a heartbeat acknowledgment from the recording server 110. Where multiple heartbeat messages are sent in step 230, one heartbeat acknowledgment may confirm all or particular heartbeat messages, or the sensor node 145 may receive respective heartbeat acknowledgments for each respective heartbeat message.

At step 237, the sensor node 145 fails to receive a heartbeat acknowledgment from the recording server 110.

In steps 240-245, the process may compare seismic data acknowledgments and heartbeat acknowledgments to predetermined criteria for verifying the satisfactory operation of a logical path. The predetermined criteria mentioned in step 240 may be the same or a different predetermined criterion as used in step 245.

At step 240, the sensor node 145 determines whether any seismic data acknowledgments pass a predetermined criterion. For instance, the predetermined criteria may be whether a seismic data acknowledgment was received in response to the seismic data sent in step 220. A received seismic data acknowledgment may qualify as “passing” or “acceptable,” and an unreceived seismic data acknowledgment may qualify as “failing.” If a seismic data acknowledgment passes the predetermined criteria, this may show that the respective logical path used for sending the seismic data is “satisfactory” or operational. In one implementation, the predetermined criteria may correspond to a time window where a seismic data acknowledgment fails if not received within the designated time window. If a seismic data acknowledgment passes the predetermined criteria, the process returns to step 220. If the seismic data acknowledgment fails the predetermined criteria, the process proceeds to step 245.

The predetermined criteria used for determining whether a heartbeat acknowledgment or seismic data acknowledgment passes may be set in advance for the seismic acquisition system 100. The predetermined criteria may also include variables or factors that are based on real-time network conditions. One such factor may include the estimated round-trip time that a heartbeat message and the respective heartbeat acknowledgment take for a particular network node, or the estimated round-trip time that seismic data and the respective seismic data acknowledgment take for a respective sensor node. The predetermined criteria may be based on an algorithm that weighs variables or factors in determining the conditions that result in a “passing” or “failing” acknowledgment.

In another implementation, where multiple streams are being used for sending seismic data, the portion or percentage of seismic data acknowledgments received in step 223 may be considered by the predetermined criteria. Passing the predetermined criteria may include receiving seismic data acknowledgments for all streams, or seismic data acknowledgments for a predetermined sufficient number of streams. In another implementation, if any portion of the seismic data acknowledgments is not received, then the seismic data acknowledgements may fail the predetermined criteria.

At step 245, the sensor node 145 determines whether any heartbeat acknowledgment passes a predetermined criterion. For instance, the predetermined criteria may be whether a heartbeat acknowledgment was received in response to the heartbeat message sent in step 230. A received heartbeat acknowledgment may qualify as “passing” or “acceptable,” and an unreceived heartbeat acknowledgment may qualify as “failing.” If a heartbeat message passes the predetermined criteria, this may show that the respective logical path used for sending the heartbeat message is “satisfactory” or operational. In one implementation, the predetermined criteria may correspond to a time window where a heartbeat acknowledgment fails if not received within the time window. If a heartbeat acknowledgment passes the predetermined criteria, the process proceeds to step 250. If a heartbeat acknowledgment fails the predetermined criteria, the process proceeds to step 255.

In one implementation, where two or more heartbeat messages are sent in step 230, the sensor node 145 determines a score for categorizing the logical path associated with the network address used in step 230. This score may be based on the time between sending the heartbeat message and the respective heartbeat acknowledgment, the number of heartbeat acknowledgments received, or a ratio or percentage of received heartbeat acknowledgments to ones not received. The predetermined criteria in step 245 may also list an acceptable score for heartbeat acknowledgment to pass the predetermined criteria.

At step 250, the sensor node 145 sends seismic data using a different network address from the current designated address used in step 220. This different network address may be the same network address used for sending the heartbeat message in step 230. For instance, if the first network address 143 is the current designated address, the sensor node 145 may send seismic data using the second network address 147. Step 250 may be described as “switching” from the primary logical path to the secondary logical path or vice versa, for sending seismic data. The different network address may now be the current designated network address. The process may then proceed to step 223 or step 227.

At step 255, the sensor node 145 terminates the endpoint association. This termination may be performed by either the sensor node 145 or the recording server 110. When either endpoint terminates an endpoint association, the seismic acquisition system 100 may stop accepting new data from either endpoint into the acquisition network 130. However, the seismic acquisition system 100 may continue to deliver data already in queue at the time of the termination to the corresponding endpoint.

In one implementation, method 200 is performed from the perspective of the recording server 110. Rather than the sensor node 145 obtaining network addresses in steps 205 and 210, the recording server 110 may instead be assigned two network addresses. In this implementation, the first router 140 would be designated for the recording server's 110 first address and the second router 150 would be designated for the recording server's 110 second address. Steps 220-255 would function as previously noted, except that the sensor node 145 would send heartbeat messages and seismic data using the recording server's 110 two network addresses as destination addresses, while the sensor node may have one source address.

FIG. 3 illustrates a flow diagram of a method 300 for managing system faults from the perspective of the recording server 110 in accordance with various implementations described herein. It should be understood that while the operational flow diagram indicates a particular order of execution of the operations, in other implementations, the operations might be executed in a different order. Further, in some implementations, additional operations or steps may be added to the method 300. Likewise, some operations or steps may be omitted.

Before step 305, the first network address 143 and the second network address 147 for the sensor node 145 may already be assigned by the first router 140 and the second router 150, respectively, or by any other network components. The recording server address 115 may also already be assigned before step 305.

At step 305, the sensor node 145 or the recording server 110 initiates an endpoint association between both endpoints. Further information about endpoint associations may be found in the discussion with reference to step 215.

At step 310, the recording server 110 receives knowledge of the first network address 143 for the sensor node 145. The first network address 143 corresponds to the primary logical path 160 between the sensor node 145 and the recording server 110. The primary logical path 160 uses the first router 140, which may be dedicated to only the primary logical path 160. The actions in step 310 may also be performed as part of the endpoint association initiated in step 305.

At step 315, the recording server 110 receives knowledge of the second network address 147 for the sensor node 145. The second network address corresponds to the secondary logical path 170 between the sensor node 145 and the recording server 110. The secondary logical path 170 uses the second router 150, which may be dedicated to only the secondary logical path 170. The actions in step 315 may also be performed as part of the endpoint association initiated in step 305.

In steps 320-327, the process may include transmitting a heartbeat message and heartbeat acknowledgment in response to the heartbeat message as a method for verifying whether the primary logical path 160 is operational or satisfactory.

At step 320, the recording server 110 sends a heartbeat message to the first network address 143. Further explanation of the heartbeat message may be found in the discussion regarding step 230 from FIG. 2.

At step 323, the recording server 110 receives a heartbeat acknowledgment for the first network address 143 (“first heartbeat acknowledgment”) corresponding to the heartbeat message sent in step 320 from the sensor node 145. Further explanation regarding how the heartbeat acknowledgment operates may be found in the discussion regarding steps 233, 237 and 245 from FIG. 2.

At step 327, the recording server 110 fails to receive a heartbeat acknowledgment for first network address 143 corresponding to the heartbeat message sent in step 320 from the sensor node 145.

In steps 330-337, the process may include transmitting a heartbeat message and heartbeat acknowledgment in response to the heartbeat message as a method for verifying whether the secondary logical path 170 is operational or satisfactory.

At step 330, the recording server 110 sends a heartbeat message to the sensor node 145 using the second network address 147.

At step 333, the recording server 110 receives a heartbeat acknowledgment from the sensor node 145 for the second network address 147 (“second heartbeat acknowledgment”).

At step 337, the recording server 110 fails to receive a heartbeat acknowledgment from the sensor node 145 for the second network address 147.

In steps 340-360, the process receives seismic data and uses the previously sent heartbeat messages and heartbeat acknowledgments for determining which network address to use for sending seismic data acknowledgments. The process may compare heartbeat acknowledgments to predetermined criteria for verifying the satisfactory operation of a logical path. The predetermined criteria mentioned in step 345 or step 355 may be the same or a different predetermined criterion as used in step 240 or step 245.

At step 340, the recording server 110 receives seismic data from the sensor node 145.

At step 345, the recording server 110 determines whether the first heartbeat acknowledgment in response to the heartbeat message for the first network address 143 passes a predetermined criterion. For instance, the predetermined criteria may be whether the first heartbeat acknowledgment was received in response to the heartbeat message sent in step 320. A received first heartbeat acknowledgment may qualify as “passing” or “acceptable,” and an unreceived first heartbeat acknowledgment may qualify as “failing.” If a heartbeat message passes the predetermined criteria, this may show that the respective logical path used for sending the heartbeat message is “satisfactory” or operational. In one implementation, the predetermined criteria may correspond to a time window where the first heartbeat acknowledgment fails if not received within the time window. For example, the time window may be a period of 10 microseconds after a heartbeat message was sent to the sensor node 145. If the first heartbeat acknowledgment passes the predetermined criteria, the process proceeds to step 350. If the first heartbeat acknowledgment fails the predetermined criteria, the process proceeds to step 355.

At step 350, the recording server 110 sends a seismic data acknowledgment to the sensor node 145 using the first network address 143. Step 350 may then proceed to step 320 to repeat the heartbeat cycle.

Referring now to step 355, the recording server 110 determines whether the second heartbeat acknowledgment in response to the heartbeat message for the second network address passes a predetermined criteria. The predetermined criteria may be the same criteria used in step 345. If the second heartbeat acknowledgment passes the predetermined criteria, the process proceeds to step 360. If the second heartbeat acknowledgment fails the predetermined criteria, the process proceeds to step 365.

In one implementation, where two or more heartbeat messages are sent in step 320 or step 330, the recording server 110 may determine a score for categorizing the logical path associated with the network address used in the respective step. This score may be based on the time between sending the heartbeat message and the respective heartbeat acknowledgment, the number of heartbeat acknowledgments received, or a ratio or percentage of received heartbeat acknowledgments to ones not received. The predetermined criteria in step 345 or step 355 may also list an acceptable score for the first or second heartbeat acknowledgments to pass the predetermined criteria.

At step 360, the recording server 110 sends a seismic data acknowledgment to the sensor node 145 using the second network address 147. Step 360 may be described as “switching” from the primary logical path to the secondary logical path or vice versa, for sending seismic data acknowledgments. Step 360 may then proceed to step 320 to repeat the heartbeat cycle.

At step 365, the recording server 110 terminates the endpoint association. Step 365 may be performed in the same or a different manner from step 255.

### Computer System

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc., that performs particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

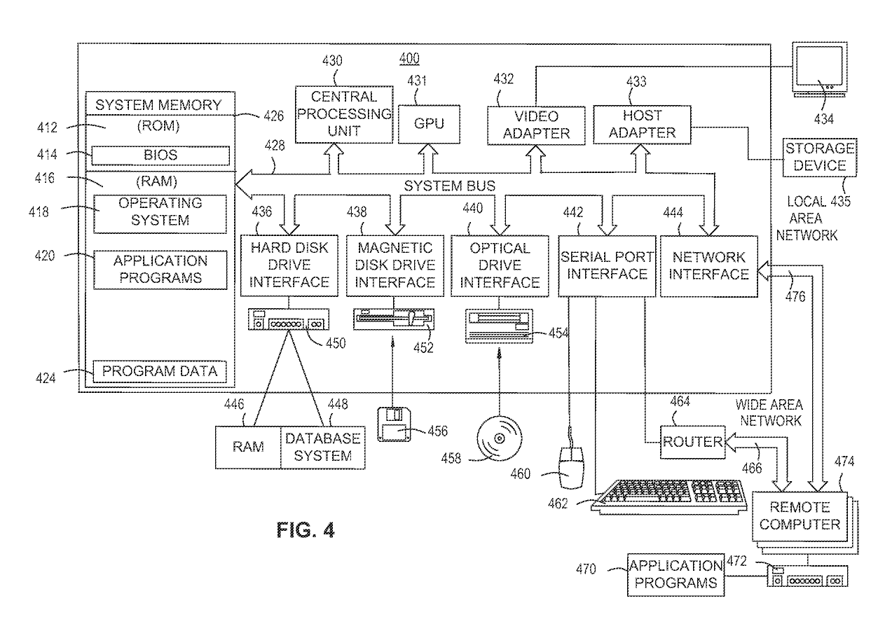

FIG. 4 illustrates a schematic diagram of a computing system 400 in which the various technologies described herein may be incorporated and practiced. Although the computing system 400 may be a conventional desktop or a server computer, as described above, other computer system configurations may be used.

The computing system 400 may include a central processing unit (CPU) 430, a system memory 426, a graphics processing unit (GPU) 431 and a system bus 428 that couples various system components including the system memory 426 to the CPU 430. Although one CPU is illustrated in FIG. 4, it should be understood that in some implementations the computing system 400 may include more than one CPU. The GPU 431 may be a microprocessor specifically designed to manipulate and implement computer graphics. The CPU 430 may offload work to the GPU 431. The GPU 431 may have its own graphics memory, and/or may have access to a portion of the system memory 426. As with the CPU 430, the GPU 431 may include one or more processing units, and each processing unit may include one or more cores. The system bus 428 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 426 may include a read-only memory (ROM) 412 and a random access memory (RAM) 446. A basic input/output system (BIOS) 414, containing the basic routines that help transfer information between elements within the computing system 400, such as during start-up, may be stored in the ROM 44.

The computing system 400 may further include a hard disk drive 450 for reading from and writing to a hard disk, a magnetic disk drive 452 for reading from and writing to a removable magnetic disk 456, and an optical disk drive 454 for reading from and writing to a removable optical disk 458, such as a CD ROM or other optical media. The hard disk drive 450, the magnetic disk drive 452, and the optical disk drive 454 may be connected to the system bus 428 by a hard disk drive interface 436, a magnetic disk drive interface 438, and an optical drive interface 440, respectively. The drives and their associated computer-readable media may provide nonvolatile storage of computer-readable instructions, data structures, program modules and other data for the computing system 400.

Although the computing system 400 is described herein as having a hard disk, a removable magnetic disk 456 and a removable optical disk 458, it should be appreciated by those skilled in the art that the computing system 400 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 400. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 400 may also include a host adapter 433 that connects to a storage device 435 via a small computer system interface (SCSI) bus, a Fiber Channel bus, an eSATA bus, or using any other applicable computer bus interface. Combinations of any of the above may also be included within the scope of computer readable media.

A number of program modules may be stored on the hard disk 450, magnetic disk 456, optical disk 458, ROM 412 or RAM 416, including an operating system 418, one or more application programs 44, program data 424 and a database system 448. The application programs 44 may include various mobile applications (“apps”) and other applications configured to perform various methods and techniques described herein. The operating system 418 may be any suitable operating system that may control the operation of a networked personal or server computer, such as Windows® XP, Mac OS® X, Unix-variants (e.g., Linux® and BSD®), and the like.

A user may enter commands and information into the computing system 400 through input devices such as a keyboard 462 and pointing device 460. Other input devices may include a microphone, joystick, game pad, satellite dish, scanner or the like. These and other input devices may be connected to the CPU 430 through a serial port interface 442 coupled to system bus 428, but may be connected by other interfaces, such as a parallel port, game port or a universal serial bus (USB). A monitor 434 or other type of display device may also be connected to system bus 428 via an interface, such as a video adapter 432. In addition to the monitor 434, the computing system 400 may further include other peripheral output devices such as speakers and printers.

Further, the computing system 400 may operate in a networked environment using logical connections to one or more remote computers 474. The logical connections may be any connection that is commonplace in offices, enterprise-wide computer networks, intranets, and the Internet, such as local area network (LAN) 476 and a wide area network (WAN) 466. The remote computers 474 may be another a computer, a server computer, a router, a network PC, a peer device or other common network node, and may include many or all of the elements describes above relative to the computing system 400. The remote computers 474 may also each include application programs 44 similar to that of the computer action function.

When using a LAN networking environment, the computing system 400 may be connected to the local network 476 through a network interface or adapter 444. When used in a WAN networking environment, the computing system 400 may include a modem 464, wireless router or other means for establishing communication over a wide area network 466, such as the Internet. The modem 464, which may be internal or external, may be connected to the system bus 428 via the serial port interface 442. In a networked environment, program modules depicted relative to the computing system 400, or portions thereof, may be stored in a remote memory storage device 472. It will be appreciated that the network connections shown are merely examples and other means of establishing a communications link between the computers may be used.

The network interface 444 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 474.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, partly on the user's computing device, as a stand-alone software package, partly on the user's computer and partly on a remote computer or entirely on the remote computer or a server computer.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
receiving a first network address for a sensor node, wherein the first network address corresponds to a primary logical path between the sensor node and a recording server, and wherein the primary logical path comprises a first router dedicated to the primary logical path;
receiving a second network address for the sensor node, wherein the second network address corresponds to a secondary logical path between the sensor node and the recording server, and wherein the secondary logical path comprises a second router dedicated to the secondary logical path; and
sending seismic data to the recording server using the first network address.

2. The method of claim 1, wherein the sensor node comprises a multi-component sensor that measures a plurality of seismic components.

3. The method of claim 2, wherein sending the seismic data comprises sending the seismic data using a plurality of streams, wherein each stream corresponds to a respective component amongst the plurality of seismic components.

4. The method of claim 3, wherein seismic data for the plurality of seismic components comprises seismic data in the x-direction, y-direction, z-direction, or a combination thereof.

5. The method of claim 3, further comprising determining whether a seismic data acknowledgment for at least one of the streams passes a predetermined criteria.

6. The method of claim 5, wherein the predetermined criteria is based on whether the seismic data acknowledgment is received or not received.

7. The method of claim 5, wherein the predetermined criteria is based on receiving the seismic data acknowledgement within a predetermined time window.

8. The method of claim 5, further comprising sending the seismic data using the second network address in response to determining that the seismic data acknowledgement for the at least one of the streams failed the predetermined criteria.

9. The method of claim 1, wherein the secondary logical path uses at least one network cable that provides a network connection between the second router and the recording server, and wherein the at least one network cable is independent from the network cables used by the primary logical path for network routing.

10. The method of claim 1, further comprising:
sending a heartbeat message to the recording server using the second network address; and
determining whether a heartbeat acknowledgment corresponding to the heartbeat message passes a predetermined criteria.

11. The method of claim 10, wherein the heartbeat acknowledgment passing the predetermined criteria comprises receiving the heartbeat acknowledgment at the sensor node.

12. The method of claim 10, further comprising:
determining whether a seismic data acknowledgment in response to the seismic data passes a predetermined criteria; and
sending the seismic data to the recording server using the second network address in response to determining that the seismic data acknowledgement failed the predetermined criteria for the seismic data acknowledgment and the heartbeat acknowledgment passed the predetermined criteria for the heartbeat acknowledgment.

13. The method of claim 12, wherein the predetermined criteria for the seismic data acknowledgment is based on receiving the seismic data acknowledgement within a predetermined time window.

14. A method, comprising:
receiving a first network address for a sensor node, wherein the first network address corresponds to a primary logical path between the sensor node and a recording server, and wherein the primary logical path comprises a first router dedicated to the primary logical path;
receiving a second network address for the sensor node, wherein the second network address corresponds to a secondary logical path between the sensor node and the recording server, and wherein the secondary logical path comprises a second router dedicated to the secondary logical path;
receiving seismic data from the sensor node; and
sending, using the first network address, a seismic data acknowledgment to the sensor node in response to receiving the seismic data.

15. The method of claim 14, further comprising:
sending a first heartbeat message to the sensor node using the first network address;
determining whether a first heartbeat acknowledgment corresponding to the first heartbeat message passes a predetermined criteria;
sending a second heartbeat message to the sensor node using the second network address; and
determining whether a second heartbeat acknowledgment corresponding to the second heartbeat message passes the predetermined criteria.

16. The method of claim 15, further comprising sending the seismic data acknowledgment to the sensor node using the second network address in response to determining that the first heartbeat acknowledgment failed the predetermined criteria and the second heartbeat acknowledgment passed the predetermined criteria.

17. A seismic acquisition system, comprising:
a recording server for collecting seismic data;
a plurality of seismic sensor nodes for acquiring seismic data;
a first router configured to assign a first network address to at least one of the seismic sensor nodes for sending seismic data from the at least one of the seismic sensor nodes to the recording server through a primary logical path; and
a second router configured to assign a second network address to the at least one of the seismic sensor nodes for sending a heartbeat message from the at least one of the seismic sensor nodes to the recording server through a secondary logical path.

18. The seismic acquisition system of claim 17, wherein the plurality of seismic sensor nodes are along a sensor strip and wherein the first router is connected to a first end of the sensor strip and the second router is connected to a second end of the sensor strip.

19. The seismic acquisition system of claim 17, wherein the recording server is configured to send a seismic data acknowledgment to the at least one of the seismic sensor nodes using the first network address in response to receiving seismic data.

20. The seismic acquisition system of claim 17, wherein the at least one of the seismic sensor nodes is configured to switch from sending seismic data using the first network address to sending seismic data using the second network address in response to a failed seismic data acknowledgment through the first network address based on a predetermined criteria.
